(19) United States
(12) Patent Application Publication
(10) Pub. No.: US 2015/0025952 A1
(43) Pub. Date: Jan. 22, 2015

(54) Method of Assigning a Prospective Member to an Enrollment Tree

(71) Applicant: Donal Jones, Miami, FL (US)

(72) Inventor: Donal Jones, Miami, FL (US)

(21) Appl. No.: 13/945,873

(22) Filed: Jul. 18, 2013

(51) Int. Cl. G06Q 30/02

(52) U.S. Cl. CPC G06Q 30/0214
USPC 705/14.16

(57) ABSTRACT

A method of incorporating a prospect into an enrollment tree of a multi-level marketing organization using a microprocessor, the enrollment tree having a tree structure and a member, each member being positioned on a level of the enrollment tree, said method having the steps of: determining a value of a sponsor goal, obtaining network information, obtaining enrollment information, identifying a vacancy in the downline of a member, assigning a prospect to the identified vacancy, and incorporating the prospect into the enrollment tree as a new member.

### CROSS-REFERENCE TO RELATED APPLICATION

This application claims the benefit of priority to U.S. Provisional Application No. 61/673,243, filed on Jul. 18, 2012, which is incorporated herein by reference in its entirety.

### BACKGROUND

Multi-level marketing (MLM) is often used by organizations that sell products and/or services to consumers. Multi-level marketing can employ a business model that allows an organization to compensate the employees of the organization based on their sales of a product and/or service, as well as the sales achieved by those employees they bring into the organization. Individuals recruit a downline of independent employees who also build a base of downline employees, which expands the overall organization.

### SUMMARY OF THE INVENTION

The present disclosure pertains to a method of incorporating a prospect into an enrollment tree of a multi-level marketing organization using a microprocessor, the enrollment tree having a tree structure and a member, each member being positioned on a level of the enrollment tree, said method having the steps of: determining a value of a sponsor goal, obtaining network information, obtaining enrollment information, identifying a vacancy in the downline of a member, assigning a prospect to the identified vacancy, and incorporating the prospect into the enrollment tree as a new member.

One aspect of the disclosure is the step of determining a value of a sponsor goal has the step of analyzing a financial package of the members of the multi-level marketing organization. Another aspect of the disclosure is the step of determining a value of a sponsor goal has the step of calculating an MLM output.

Another aspect of the disclosure is the step of identifying a vacancy in the downline of a member has the step of identifying a vacancy in the downline of the member who recruited the prospect. Another aspect of the disclosure is the step of identifying a vacancy in the downline of the member has the step of identifying a vacancy of a member that resides in the highest level in the downline of the member. Another aspect of the disclosure is the step of identifying a vacancy in the downline of the member has the steps of determining the highest level of all members with a vacancy and determining the member characterized in the immediate upline level from the highest level with the vacancy that does not have a downline member recruited by the network with an enrollment date later than the enrollment date of another network recruited member characterized in the same level as the downline member. Another aspect of the disclosure is the step of identifying a vacancy in the downline of the member has the steps of determining the highest level of all members with a vacancy and determining the member characterized in the immediate upline level from the highest level with the most vacancies in the immediate downline of the member. Another aspect of the disclosure is the step of identifying a vacancy in the downline of the member has the steps of determining the highest level of all members with a vacancy and determining the member with immediate downline vacancies and characterized in the immediate upline level from the highest level where the member has the earliest enrollment date. Another aspect of the disclosure is the step of identifying a vacancy in the downline of the member has the steps of creating a vacancy list and identifying a vacancy utilizing the vacancy list. Another aspect of the disclosure is the step of identifying a vacancy has the step of postponing the assignment of the prospect to a vacancy in the downline of a member.

Another aspect of the disclosure is the step of incorporating the prospect into the enrollment tree as a new member has the step of incorporating enrollment information associated with the prospect into a vacancy list. Another aspect of the disclosure has the step of assigning the sponsor goal to each immediate downline of a member. Another aspect of the disclosure has the step of postponing the assignment of the prospect to a vacancy in the downline of a member. Another aspect of the disclosure has the step of reactivating the assignment of the prospect to a vacancy in the downline of a member. Another aspect of the disclosure has the step of calculating a compensation amount for a member based on the financial package of the member.

With those and other objects, advantages and features on the invention that may become hereinafter apparent, the nature of the invention may be more clearly understood by reference to the following detailed description of the invention, the appended claims, and the drawings attached hereto.

### BRIEF DESCRIPTION OF THE DRAWINGS

The accompanying drawings, which are incorporated herein and form part of the specification, illustrate various embodiments of the present invention and together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a pedigree chart of an enrollment tree according to an exemplary embodiment.

FIG. 2 is a block diagram of an electronic device according to an exemplary embodiment.

FIG. 3 is a flow chart of a process according to an exemplary embodiment.

FIG. 4 is a pedigree chart of an enrollment tree according to an exemplary embodiment.

### DETAILED DESCRIPTION

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense, and the scope of the present invention is defined by the appended claims.

In one embodiment, the method has the step of incorporating a prospective member or prospect into a multi-level marketing organization. A multi-level marketing organization can be any organization with a system in which a member of the organization is compensated not only for sale they personally generate, but also for the sales of the other salespeople that they recruit. A member can include independent distributors, independent non-salaried salespeople, associates, independent business owners, dealers, franchise owners, sales consultants, consultants, independent agents, or the like. Members are part of the multi-level marketing organization and represent the company that produces the products or provides the services they sell. They are awarded a commission based upon the commissionable sales volume of product sold or purchased through their own efforts as well as the effort of the members in the downline of the member.

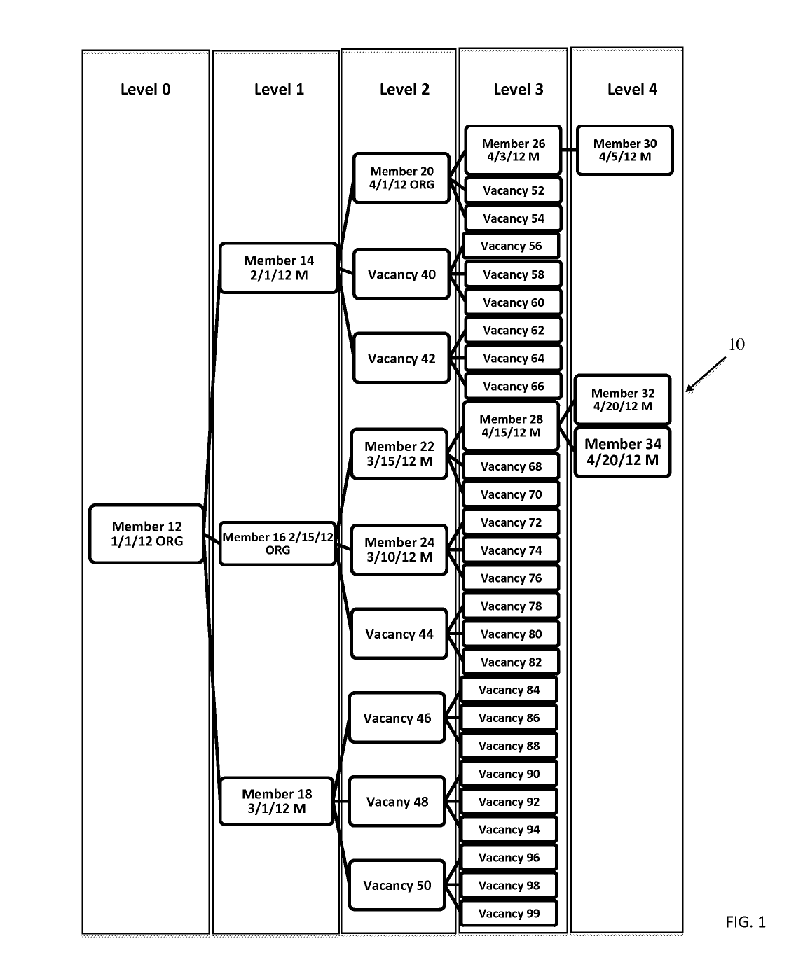

In one embodiment, as shown in FIG. 1, an enrollment tree 10 of a multi-level marketing organization is shown. The enrollment tree 10 or structure tree represents the hierarchical nature of the multi-level marketing organization. As shown in FIG. 1, the enrollment tree 10 has levels within a downline of a member, for example, level 0, 1, 2, 3, and 4. A level represented in a figure directly above another level is described as being higher than the other level. A level can have at least one member and/or vacancy. For example, as shown in FIG. 1, level 1 is higher than level 2. The enrollment tree 10 is structured with each square or node of FIG. 1 representing a member or vacancy in the enrollment tree 10. For example, as shown in FIG. 1, level 0 has member 12, level 1 has members 14, 16, and 18, and level 2 has members 20, 22, 24 and vacancies 40, 42, 44, 46, 48 and 50. Members and/or vacancies in a level below the level of a member of the enrollment tree 10 may be said to be in the downline of the member. For example, member 18 is in the downline of member 12 and vacancy 40 is in the downline of member 14.

As shown in FIG. 1, where a square represents a member, an enrollment date and a recruiting source are depicted with each member. The enrollment date is the date the member enrolled in the multi-level marketing organization. The recruiting source is the source by which the member was recruited to join the multi-level marketing organization, for example, a member or an organization. The organization can be a third party marketing service (i.e. an independently enrolled party, a party hired or contracted by the multi-level marketing organization to recruit members) or the multi-level marketing organization. As a recruiting source, members can recruit prospects by soliciting acquaintances, friends and family, hosting meetings in which acquaintances, friends, or family of the member's friends attend the meeting, sending recruiting information (i.e. videos, electronic invitations to live promotional events, etc.) from an organization's website, or the like. An organization can recruit prospects by utilizing internet marketing, social media, search engine optimization, pay-per-click, television, radio, mobile marketing, live promotional events, or the like. For example, where prospects are recruited utilizing internet marketing, a prospect is presented the structure of the multi-level marketing organization in detail and the benefit of using the multi-level marketing organization to accomplish their income goals. In the figures, “M” identifies that the member was recruited by a member and “ORG” identifies that the member was recruited by an organization.

For example, members 22 and 24 are shown as having been personally recruited by member 16, and member 22 is classified as being on level 2 of the enrollment tree 10. Similarly, member 26 has been recruited by member 20, member 28 has been recruited by member 22, member 30 has been recruited by member 26, and members 32 and 34 have been recruited by member 28. Each of members 14, 16, and 18 are classified as being on level 1 of the member's 12 enrollment tree 10, each of members 20, 22, and 24 are classified as being on level 2 of the member's 12 enrollment tree 10, and each of members 26 and 28 are classified as being on level 3 of the member's 12 enrollment tree 10. The enrollment tree 10 can extend to include additional members personally recruited by any of the members shown in the enrollment tree 10.

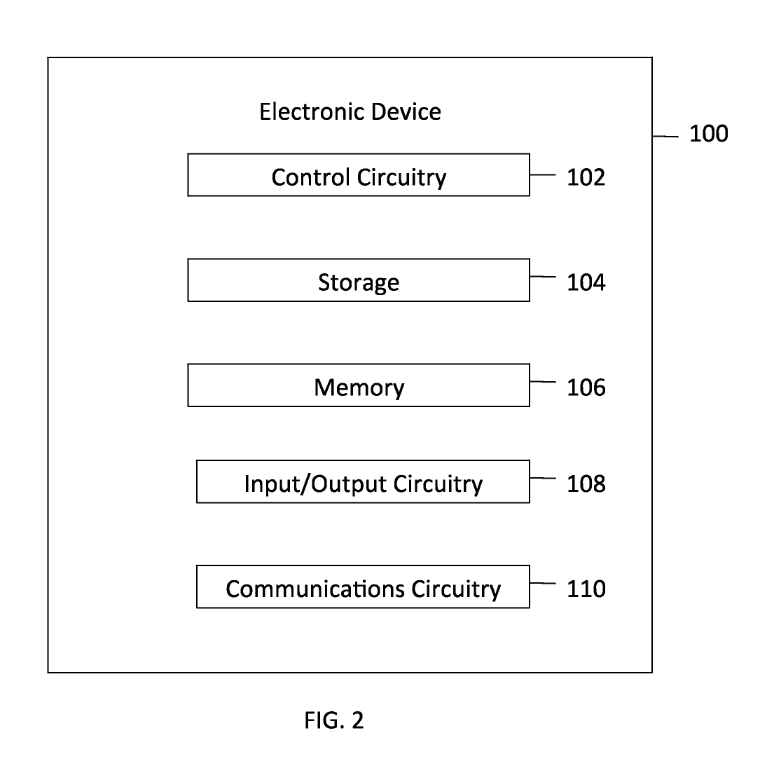

FIG. 2 shows an illustrative electronic device 100 for providing a device application for interfacing with a host. Electronic device 100 can include control circuitry 102, storage 104, memory 106, input/output (“I/O”) circuitry 108, and/or communications circuitry 110. In some embodiments, one or more of the components of the electronic device 100 can be combined or omitted (e.g., storage 104 and memory 106 may be combined). In some embodiments, the electronic device 100 can include other components not combined or included in those shown in FIG. 2 (e.g., a display), or several instances of the components shown in FIG. 2. Only one of each of the components is shown in FIG. 2.

The electronic device 100 can include any suitable type of electronic device 100. For example, the electronic device 100 can include a substantially fixed electronic device 100, such as a desktop computer. As another example, electronic device 100 can include a larger portable electronic device 100, such as a laptop or tablet computer. As another example, the electronic device 100 can include a portable electronic device 100 that the user may hold in his or her hand, such as a digital media player, a personal e-mail device, a personal data assistant (“PDA”), a cellular telephone, a handheld gaming device, or a digital camera.

Control circuitry 102 can include any processing circuitry or unit including a microprocessor, or processor operative to control the operations and performance of the electronic device 100. For example, control circuitry 102 can be used to run operating system applications, firmware applications, or any other application. In some embodiments, control circuitry 102 can drive a display and process inputs received from an interface.

Storage 104 can include, for example, one or more storage mediums including a hard-drive, solid state drive, flash memory, permanent memory such as ROM, any other suitable type of storage component, or any combination thereof. Storage 104 can store, for example, application data (e.g., for implementing functions on the electronic device 100), firmware, information (e.g., downline information, member information, compensation information, vacancy information, or network information), authentication information (e.g. libraries of data associated with authorized users), and any other suitable data or any combination thereof.

Memory 106 can include cache memory 106, semi-permanent memory such as RAM, and/or one or more different types of memory 106 used for temporarily storing data. In some embodiments, memory 106 can also be used for storing data used to operate electronic device 100 applications, or any other type of data that can be stored in storage 104. In some embodiments, memory 106 and storage 104 can be combined as a single storage 104 medium. In some embodiments, memory 106 and storage 104 are coupled to the processing unit.

I/O circuitry 108 can be operative to convert (and encode/decode, if necessary) analog signals and other signals into digital data. In some embodiments, I/O circuitry 108 can also convert digital data into any other type of signal, and vice-versa. For example, I/O circuitry 108 can receive and convert physical contact inputs (e.g., from a multi-touch screen), physical movements (e.g., from a mouse or sensor), analog audio signals (e.g., from a microphone), or any other input. The digital data can be provided to and received from control circuitry 102, storage 104, memory 106, or any other component of electronic device 100. Although I/O circuitry 108 is illustrated in FIG. 2 as a single component of electronic device 100, several instances of I/O circuitry 108 can be included in electronic device 100.

Electronic device 100 can include any suitable interface or component for allowing a user to provide inputs to I/O circuitry 108. For example, electronic device 100 can include any suitable input mechanism, for example, a button, keypad, mouse, dial, a click wheel, or a touch screen. In some embodiments, electronic device 100 can include a capacitive sensing mechanism, or a multi-touch capacitive sensing mechanism.

In some embodiments, electronic device 100 can include specialized output circuitry associated with output devices such as, for example, one or more audio outputs. The audio output can include one or more speakers (e.g., mono or stereo speakers) built into electronic device 100, or an audio component that is remotely coupled to electronic device 100 (e.g., a headset, headphones or earbuds that can be coupled to communications device with a wire or wirelessly).

In some embodiments, I/O circuitry 108 can include display circuitry (e.g., a screen or projection system) for providing a display visible to the user. For example, the display circuitry can include a screen (e.g., an LCD screen) that is incorporated into electronic device 100. As another example, the display circuitry can include a movable display or a projecting system for providing a display of content on a surface remote from electronic device 100 (e.g., a video projector). In some embodiments, the display circuitry can include a coder/decoder (Codec) to convert digital media data into analog signals. For example, the display circuitry (or other appropriate circuitry within the electronic device 100) can include video Codecs, audio Codecs, or any other suitable type of Codec.

The display circuitry also can include display driver circuitry, circuitry for driving display drivers, or both. The display circuitry can be operative to display content (e.g., media playback information, application screens for applications implemented on the electronic device 100, information regarding ongoing communications operations, information regarding incoming communications requests, or device operation screens) under the direction of control circuitry 102. Alternatively, the display circuitry can be operative to provide instructions to a remote display.

Communications circuitry 110 can include any suitable communications circuitry 110 operative to connect to a communications network and to transmit communications (e.g., voice or data) from electronic device 100 to other devices within the communications network. Communications circuitry 110 can be operative to interface with the communications network using any suitable communications protocol such as, for example, Wi-Fi (e.g., a 802.11 protocol), Bluetooth®, radio frequency systems (e.g., 900 MHz, 1.4 GHz, and 5.6 GHz communication systems), infrared, GSM, GSM plus EDGE, CDMA, quadband, and other cellular protocols, VoIP, or any other suitable protocol.

Electronic device 100 can include one or more instances of communications circuitry 110 for simultaneously performing several communications operations using different communications networks, although only one is shown in FIG. 2. For example, electronic device 100 can include a first instance of communications circuitry 110 for communicating over a cellular network, and a second instance of communications circuitry 110 for communicating over Wi-Fi or using Bluetooth®. In some embodiments, the same instance of communications circuitry 110 can be operative to provide for communications over several communications networks.

In one embodiment, the electronic device 100 may include a device application to interface with at least one server thereby providing the electronic device 100 with the ability to create and present transmissions to a server. For example, through the device application of the electronic device 100, the user can connect to a server, for example, a host server, website server, database server, or the like. The host server can be any server that receives and transmits communication between the electronic device 100 and the host, the electronic device 100 and the database server, or the like. For example, the host server can receive communication from the host and transmit the communication to the electronic device 100. The database server can be any server that allows for the storage of data (e.g. downline information, member information, compensation information, vacancy information, network information, enrollment information, sponsored goal, or the like). The database server can be associated with any organization, for example multi-level marketing organization and/or a third party marketing service. In one embodiment, the website server communicates directly with the electronic device 100. In one embodiment, the server may include a server application to allow the server to create and present transmissions to another server or the electronic device 100.

Communication between the electronic device 100 and the host server, the electronic device 100 and the website server, the electronic device 100 and the database server, the host server and the database server, a first database server and a second database server, and the host server and the website server may be accomplished through any suitable network that may be provided by one or more communication interface, for example, WLAN, WAN, or LAN connection. Specifically, by way of example, the network may be a wireless internet connection established by way of the WLAN interface, a local area network connection established through the LAN interface, or a wide area network connection established by way of the WAN interface, which may include one of various WAN mobile communication protocols, such as a General Packet Radio Service (GPRS) connection, an EDGE connection (Enhanced Data rates for GSM Evolution connection), or a 3G connection, such as in accordance with the IMT-2000 standard. One or more of the data encryption techniques and security protocols (e.g., SSL or TSL protocols) may be further utilized in order to facilitate the secure transmission of the data (e.g. downline information) from the electronic device 100 to the host server.

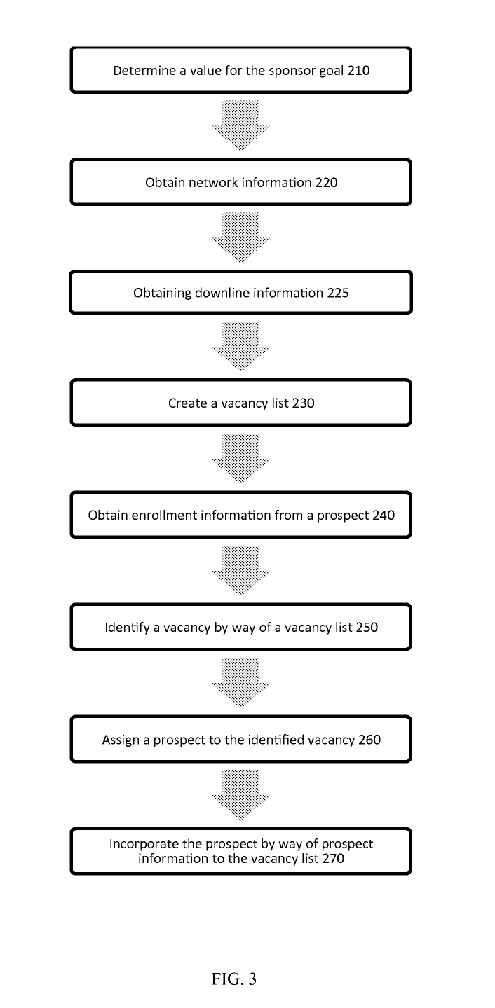

In one embodiment, as shown as block 210 of FIG. 3, the method has the step of determining a value for the sponsor goal. The sponsor goal is the desired number of sponsored members characterized in the immediate downline of the member whereby upon achieving the sponsor goal the need for the member to recruit additional members is alleviated. The sponsored goal can be any number of members. In one embodiment, where the member has sponsored, in the immediate downline of the member, the number of members required to meet the sponsor goal, the member is not required to recruit additional members. Where the member has not obtained the required number of sponsored members in the immediate downline of the member thereby having not obtained the sponsored goal for a level, the member has a vacancy for receiving a member to obtain the sponsored goal. When the member has fulfilled the sponsor goal, the member is capable of obtaining the highest earning percentage from members in the downline of the member. The value of the sponsor goal is determined by evaluating the financial package of the multi-level marketing organization. The financial package can be or include any financial program, operating procedure, compensation plan, promotion plan, number of downline members, downline information, or the like. The financial package can be analyzed to determine a sponsor goal that will allow for at least one MLM output, such as, without limitation, maximum overall member earning potential, maximum member earning potential of at least one level, or the like. For example, a network with one compensation plan and promotion plan could require a greater sponsor goal value than another in order to maximize the member's overall earning potential or in the first two levels. The number of the sponsored goal is assigned to each immediate downline of a member. For example, as shown in FIG. 1, the sponsored goal is three where the combination of members 14, 16, and 18 represent the fulfillment of the sponsored goal of the immediate downline of member 12 and members 22, 24, and vacancy 44 represent the fulfillment of the sponsored goal of the immediate downline of member 16. Once the sponsored goal of one level in the downline of one member is reached, a prospect is assigned to the vacancy in the immediate downline level from the level to which the sponsored goal was reached. For example, since member 12 has met the sponsor goal for level 1 in the downline of member 12, the next prospect assigned to the downline of the member 12 is assigned to level 2 of the downline of the member 12.

In one embodiment, a number of nodes corresponding to the sponsor member is assigned to the immediate downline of each member 12 of the enrollment tree 10.

In one embodiment, as shown as block 220 of FIG. 3, the method has the step of obtaining network information. Network information is any information specific to the structure of the network that is associated with the operations of the network, for example, compensation information, advancement information, achievement award information, number of the sponsor goal, or the like. In one embodiment, the network information is obtained by allowing users or individuals with administrative privileges of the method to enter the network information into a public web site or a mobile application. Once the network information is obtained, the network information is transmitted to a server and stored on a database, thereby allowing for the network information to be retrieved at a future date.

The database may be local and/or may be remote with respect to the server. The database can be, for example, without limitation, a MySQL database, XML files, or the like. The database can be incorporated into a server using scripting language. Scripting language can be, for example, PHP, ASP, JavaScript, HyperText Markup Language (HTML), or the like. The server can be configured to receive information from an electronic device 100 or another server and transmit information to an electronic device 100 or another server. The database can be sectioned into or have a plurality of sub-databases, for example, a sponsor goal database, downline database, member database, vacancy database, network database, or the like.

In one embodiment, as shown as block 225 of FIG. 3, the method has the step of obtaining downline information. Downline information can include any information associated with a member for example, member ID, member name, member enrollment date, recruiting source, member level (i.e. the level of the downline associated with the member), member rank or the like, vacancy information, for example, the number of vacancies in a specific level of a specific downline of a member, the number of vacancies in the downline of a specific member, the total number of vacancies in an enrollment tree 10, or the like. In one embodiment, the downline information is obtained by allowing users or individuals to enter the downline information into a public web site or a mobile application. Once the downline information is obtained, the downline information is transmitted to a server and stored on a database, thereby allowing for the downline information to be retrieved at a future date. The database may be similar to the database for storing network information described herein.

In one embodiment, as shown as block 230 of FIG. 3, the method has the step of creating a vacancy list. In one embodiment, the vacancy list is created by the application by populating the vacancy list with downline information. Once the vacancy list is created, the vacancy list is transmitted to a server and stored on a database, thereby allowing for the vacancy list to be retrieved at a future date. The vacancy list can be sorted by any type of downline information, for example, member enrollment date.

In one embodiment, as shown as block 240 of FIG. 3, the method has the step of obtaining enrollment information from a prospect. In one embodiment, the application obtains the enrollment information from a prospect. Enrollment information can be any information associated with a prospect with the multi-level marketing organization, for example, name, address, telephone number, enrollment date, referral source, recruiting member's identification number, (i.e. a unique number assigned to each member), email address, or the like. The application presents a questionnaire to the prospect thereby prompting the prospect to provide the requested information. For example, where the prospect was recruited by a member, the application prompts the prospect to provide the multi-level marketing organization identification number of the recruiting member, thereby signaling that the prospect is to be assigned to a vacancy in the downline of the recruiting member. In one embodiment, the enrollment information is obtained by allowing users to enter enrollment information into a public web site or a mobile application. Once the enrollment information is obtained, the enrollment information is transmitted to a server and stored on the database, thereby allowing for the enrollment information to be retrieved at a future date.

The source for the information associated with the method, for example, without limitation, enrollment information, information related to the financial package, downline information, vacancy information, or the like can originate from an appropriate source for the information, for example, without limitation, a prospect, member, multilevel marketing organization, or the like.

In one embodiment, as shown as block 250 of FIG. 3, the method has the step of identifying a vacancy for the purpose of determining the vacancy in which to assign a prospect. In one embodiment the application identifies the vacancy.

In one embodiment, where a member recruited the prospect, a vacancy in the downline of the member who recruited the prospect is identified. In one embodiment, the vacancy in the downline of the member who recruited the prospect is identified, where the vacancy resides in the highest level in the downline of the member. For example, referring to FIG. 1, where level 1 in the downline of the member has not obtained the sponsored goal, the vacancy in level 1 in the downline of the member is identified. Specifically, as shown in FIG. 1, where member 18 recruited the prospect, the vacancy 46 of level 2 in the downline of member 18 is identified. By way of another example, as shown in FIG. 1, where the member 24 recruited the prospect, the vacancy 72 of level 3 in the downline of member 24 is identified.

In one embodiment, where an organization or network recruited the prospect, the vacancy of a member is identified. Here, the vacancy of a member is identified by determining the highest level of all members with a vacancy and determining the member characterized in the immediate upline level from the highest level with the vacancy that does not have a downline member recruited by the network with an enrollment date later than the enrollment date of another network recruited member characterized in the same level as the downline member. For example, as shown in FIG. 1, where an organization recruited the prospect, member 20 is the most recent enrolled member, member 20 was recruited by an organization, level 2 is identified as the highest level with a vacancy, member 16 is identified as the member in the immediate upline level that does not have a downline member recruited by the network with an enrollment date later than the enrollment date of another network recruited member in level 2, the vacancy 44 is identified.

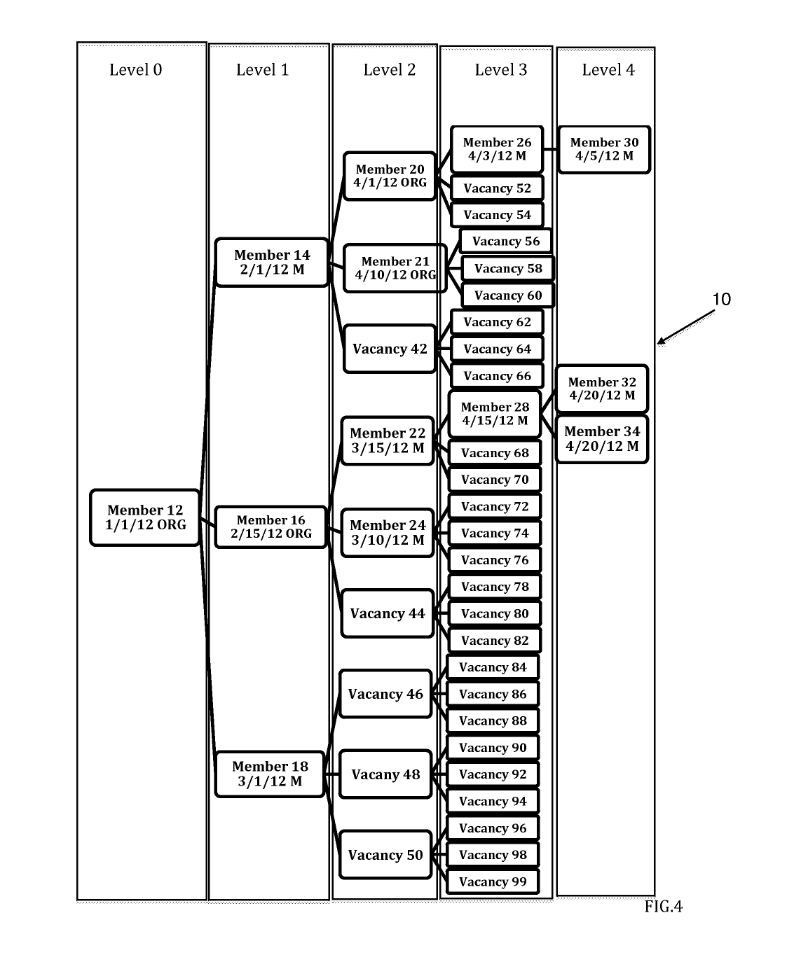

In one embodiment, the vacancy is identified regardless of whether the most recent enrolled member was enrolled by an organization or another member. By way of another example, as shown in FIG. 4, where an organization recruited the prospect, level 2 is identified as the highest level with a vacancy, member 21 is the most recent enrolled member, member 21 was recruited by another member, member 16 is identified as the member in the immediate upline level that does not have a downline member recruited by the network with an enrollment date later than the enrollment date of another network recruited member in level 2, the vacancy 44 is identified.

In one embodiment, where an organization recruited the prospect, the vacancy of a member is identified by determining the highest level of all members with a vacancy and determining the member characterized in the immediate upline level from the highest level with the most vacancies in the immediate downline of the member. In this embodiment, if two members have the same number of vacancies, the vacancy in the downline of the member with the earliest enrollment date is identified. For example, as shown in FIG. 1, where an organization recruited the prospect, level 2 is identified as the highest level with a vacancy, member 18 is identified as the member in the immediate upline level with the most vacancies in the immediate downline of the member, vacancy 46 is identified.

In one embodiment, where an organization recruited the prospect, the vacancy of a member is identified by determining the highest level of all members with a vacancy and determining the member with immediate downline vacancies and characterized in the immediate upline level from the highest level where the member has the earliest enrollment date.

For example, as shown in FIG. 1, where an organization recruited the prospect, level 2 is identified as the highest level with a vacancy, member 14 is identified as the member in the immediate upline level with the earliest enrollment date, vacancy 40 is identified.

In one embodiment, the vacancy is identified by utilizing the vacancy list. In one embodiment, the application identifies the vacancy utilizing the vacancy list. The vacancy list allows for the determination of the vacancy to which to assign a prospect.

Where the member recruited the prospect, the application scans the downline information of the recruiting member in the vacancy list and identifies a vacancy that resides in the highest level in the downline of the member. For example, referring to FIG. 1, where the member recruits the prospect and level 1 in downline with the member has not obtained the sponsored goal, the application scans the downline information of the recruiting member in the vacancy list and identifies a vacancy in level 2 in the downline of the member. Specifically, as shown in FIG. 1, where member 16 recruited the prospect, the application scans the downline information of the recruiting member 16 in the vacancy list and identifies vacancy 44 of level 2 in the downline of member 16. By way of another example, as shown in FIG. 1, where the member 12 recruited the prospect, the application scans the downline information of the recruiting member 12 in the vacancy list and identifies vacancy 40 of level 2 in the downline of member 12.

Where an organization recruited the prospect, the application scans the downline information of all the members of the vacancy list thereby determining the highest level with a vacancy of all the members and determining the member immediately upline from the highest level with the vacancy with the earliest enrollment date. For example, referring to FIG. 1, where an organization recruited the prospect and level 2 has not obtained the sponsored goal, the application scans the downline information of all the members of the vacancy list and identifies a vacancy in level 2. Specifically, as shown in FIG. 1, where an organization recruited the prospect, the application identifies level 2 as the highest level with a vacancy, the application identifies member 16 as the member in the immediate upline level that does not have a downline member recruited by the network with an enrollment date later than the enrollment date of another network recruited member in level 2, the application identifies vacancy 44.

In one embodiment, as shown as block 260 of FIG. 3 the method has the step of assigning a prospect to the identified vacancy. The prospect is assigned to a vacancy by any method known in the art. For example, as shown in FIG. 1, where vacancy 44 is identified, the prospect is assigned to vacancy 44 in the downline of member 16.

In one embodiment, as shown as block 270 of FIG. 3, once the prospect has been assigned to a vacancy and thus the downline of a member, the method has the step of incorporating the prospect into the enrollment tree as a new member, thereby allowing the downline of this new member to be considered for subsequent prospect assignments. In one embodiment, the prospect is incorporated into the enrollment tree by incorporating the enrollment information into the vacancy list. In one embodiment, the application transmits the prospect information to a server and allowing it to be stored on the database, thereby allowing for the prospect information to be retrieved at a future date. Prospect information can be any information associated with a prospect or a new member, for example, name, contact information, identification number, enrollment date, placement in the downline of the member, or the like.

In one embodiment, the method has the step of postponing the assignment of the prospect to a vacancy in the downline of a member. This can allow the member to choose not to receive a prospect recruited by the organization, thereby leaving a time period open to fill a vacancy with a prospect recruited by the member. In one embodiment, the application postpones the assignment of the prospect to a vacancy in the downline of a member during a specified period. For example, upon enrollment of a prospect with the multi-level marketing organization, the member communicates to the application to postpone the assignment of the organization recruited prospects until two months have transpired from the enrollment date, thereby allowing the member to fill vacancies with prospects recruited by the member during the postponement period.

In one embodiment, the method has the step of reactivating the assignment of the prospect to a vacancy in the downline of a member. This can allow the member to receive a prospect recruited by the organization when the assignment of the prospect has been previously postponed.

In one embodiment, the method has the step of calculating a compensation amount for a member based on the financial package of the member. In one embodiment, the application identifies the financial package of the member and components therein and calculates a compensation amount.

Compensation for one member, i.e. from the percentage of commissionable sales volume of the other members in the downline of the member, increases as the prospects are assigned to the downline of member. For example, as shown in FIG. 1, a member may earn 5% of the commissionable sales volume of the members of the first level for each prospect that is assigned to the downline of the member. Specifically, where the sponsored goal is three, the member 12 receives 5% of the commissionable sales volume of the members 14, 16, and 18 in level one of the downline of the member, and 5% of the commissionable sales volume of members 20, 22, and 24 in level 2.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

Modifications and variations of the present invention are possible in light of the above teachings. It is therefore to be understood that the invention may be practiced otherwise than as specifically described herein.

What is claimed is:

1. A method of incorporating a prospect into an enrollment tree of a multi-level marketing organization using a microprocessor, the enrollment tree having a tree structure and a member, each member being positioned on a level of the enrollment tree, said method comprising the steps of:
determining a value of a sponsor goal,
obtaining network information,
obtaining enrollment information,
identifying a vacancy in the downline of a member,
assigning a prospect to the identified vacancy, and
incorporating the prospect into the enrollment tree as a new member.

2. The method of claim 1 wherein the step of determining a value of a sponsor goal comprises the step of analyzing a financial package of the members of the multi-level marketing organization.

3. The method of claim 1 wherein the step of determining a value of a sponsor goal comprises the step of calculating an MLM output.

4. The method of claim 1 wherein the step of identifying a vacancy in the downline of a member comprises the step of identifying a vacancy in the downline of the member who recruited the prospect.

5. The method of claim 4 wherein the step of identifying a vacancy in the downline of the member comprises the step of identifying a vacancy of a member that resides in the highest level in the downline of the member.

6. The method of claim 1 wherein the step of identifying a vacancy in the downline of the member comprises the steps of:
determining the highest level of all members with a vacancy, and
determining the member characterized in the immediate upline level from the highest level with the vacancy that does not have a downline member recruited by the network with an enrollment date later than the enrollment date of another network recruited member characterized in the same level as the downline member.

7. The method of claim 1 wherein the step of identifying a vacancy in the downline of the member comprises the steps of:
determining the highest level of all members with a vacancy, and
determining the member characterized in the immediate upline level from the highest level with the most vacancies in the immediate downline of the member.

8. The method of claim 1 wherein the step of identifying a vacancy in the downline of the member comprises the steps of:
determining the highest level of all members with a vacancy, and
determining the member with immediate downline vacancies and characterized in the immediate upline level from the highest level where the member has the earliest enrollment date.

9. The method of claim 1 wherein the step of identifying a vacancy in the downline of the member comprises the steps of creating a vacancy list and identifying a vacancy utilizing the vacancy list.

10. The method of claim 1 wherein the step of identifying a vacancy comprises the step of postponing the assignment of the prospect to a vacancy in the downline of a member.

11. The method of claim 1 wherein the step of incorporating the prospect into the enrollment tree as a new member comprises the step of incorporating enrollment information associated with the prospect into a vacancy list.

12. The method of claim 1 further comprising the step of assigning the sponsor goal to each immediate downline of a member.

13. The method of claim 1 further comprising the step of postponing the assignment of the prospect to a vacancy in the downline of a member.

14. The method of claim 14 further comprising the step of reactivating the assignment of the prospect to a vacancy in the downline of a member.

15. The method of claim 1 further comprising the step of calculating a compensation amount for a member based on the financial package of the member.
